(19) United States
(12) Patent Application Publication
(10) Pub. No.: US 2009/0129604 A1
(43) Pub. Date: May 21, 2009

(54) SOUND FIELD CONTROL METHOD AND SYSTEM

(75) Inventors: Akihiko Enamito, Kawasaki-shi (JP); Takahiro Hiruma, Tokyo (JP)

Correspondence Address: Charles N.J. Ruggiero, Esq.;Ohlandt, Greeley, Ruggiero & Perle, L.L.P., One Landmark Square, 10th Floor, Stamford, CT, 06901-2682, US

(73) Assignee: KABUSHIKI KAISHA TOSHIBA

(21) Appl. No.: 12/262,077

(22) Filed: Oct. 30, 2008

(30) Foreign Application Priority Data
Oct. 31, 2007 (JP) 2007-284421

(51) Int. Cl. H04R 29/00; H04R 3/00

(52) U.S. Cl. 381/58; 381/122

(57) ABSTRACT

Characteristics of spatial transmission from a speaker to a microphone contained in a remote controller and set in a listening area and in a non-listening area are measured. A plurality of different types of sound field control effects is calculated on the basis of the spatial transmission characteristics to predict the plurality of types of sound field control effects. The plurality of types of sound field control effects is displayed and presented to a user. The speaker is driven by using a control sound source corresponding to one sound field control effect selected from the plurality of types of sound field control effects by the user operating the remote controller to perform effective sound field control in the listening area and in the non-listening area.

### CROSS-REFERENCE TO RELATED APPLICATIONS

This application is based upon and claims the benefit of priority from prior Japanese Patent Application No. 2007-284421, filed Oct. 31, 2007, the entire contents of which are incorporated herein by reference.

### BACKGROUND OF THE INVENTION

1. Field of the Invention

The present invention relates to a sound field control method and system in which a sound field generated by contents sounds (music, sounds, or sound effects) radiated by a speaker of an AV apparatus is controlled by an electric acoustic signal processing technique.

2. Description of the Related Art

Various methods are used to operate a speaker system in an audio visual (AV) apparatus such as a television receiver (TV), an acoustic apparatus (audio system), or a home theater system. Typically, a remote controller is used which is commonly attached to a TV. A user can use not only an operation section provided in an apparatus main body but also the remote controller in operating an appropriate adjustable switch to obtain a desired sound volume.

A method that is essentially similar to that for a TV remote controller except for the form of sound field control is used for a home theater system. That is, with the home theater system, the user uses a remote controller to input the characteristics of a room and the location of speakers so as to obtain a desired sound field; the user thus controls the amplitudes and phases of music, sounds, sound effects, and the like (hereinafter collectively referred to as contents sounds) output from the speakers to reproduce stereophony having a surround-sound effect.

A system reproducing stereophony has recently been implemented in personal computers (PCs); a 5.1 channel speaker system is installed in the personal computer, and the position of the speakers and a user listening position are displayed on a PC screen so that the user can use a mouse to operate the user listening position. This also applies to game machines.

On the other hand, JP-A 2007-121439 (KOKAI) discloses a technique of using a first sound pressure detecting point and a second sound pressure detecting point (microphones) installed in a audible area (listening area) and an inaudible area (non-listening area), respectively, to detect sounds from a main sound source and a control sound source based on acoustic signals and radiated by M main sound source speakers and N+1 control sound source speakers, to control the amplitude and phase of the main sound source so that the sum of sound pressures from the control sound source detected by the first sound pressure detecting point is reduced, while the sum of sound pressures from the control sound source and the main sound source detected by the second sound pressure detecting point is minimized.

A sound field realized by the above-described conventional techniques is ordinarily controlled by the user listening to the contents sounds so as to suit the user's taste. In this case, by listening to the contents sounds from the speakers, the user can determine whether or not a sound field control effect exerted by a manual operation using the remote controller or the like suits the user's taste. However, the sound field realized by the user's operation may be noise to surrounding people who do not want to listen to the contents sounds.

Thus, desirably, the same speakers are used to achieve trade-off in which at the same time and in the same space, with a sound field suiting the user's taste maintained, another sound field is created in which the people other than the user can avoid listening to the contents sounds. Such a requirement cannot be met by the user's check on the sound field as in the conventional art.

That is, the user needs to check not only a spatial field (listening area) in which the user actually listens to a TV or a surround system but also a sound field in another spatial field (non-listening area) that is relatively close to the listening area. It is cumbersome for the user to switch the sounds from the main sound source speakers during listening in order to check the sound field. Desirably, the user can check the sound field as simply as in the ordinary adjustment of the volume using the remote controller. Furthermore, the technique in JP-A 2007-121439 (KOKAI) enables sound field control such that the sound pressure is suppressed in the non-listening area, but has difficulty allowing the user to select the sound field control effect.

### BRIEF SUMMARY OF THE INVENTION

An aspect of the present invention provides a sound field control method comprising a step of, in order to control a sound field generated by an AV apparatus including a speaker, measuring a characteristic of spatial transmission from the speaker to a first microphone contained in a remote controller for controlling the AV apparatus when the first microphone is placed in a listening area, a step of measuring the characteristic of spatial transmission from the speaker to the first microphone or another, second microphone when the first or second microphone is placed in a non-listening area, a step of calculating amplitudes of control sound sources corresponding to a plurality of different types of sound field control effects on the basis of the spatial transmission characteristics, a step of predicting the plurality of types of sound field control effects according to the amplitudes, a step of displaying and presenting the plurality of types of sound field control effects to a user, a step of outputting a control sound source with the amplitude and a phase corresponding to one sound field control effect selected from the plurality of types of sound field control effects by the user operating the remote controller, and a step of using the control sound source to drive the speaker in order to exert the one sound field control effect.

### BRIEF DESCRIPTION OF THE SEVERAL VIEWS OF THE DRAWING

FIG. 1 is a diagram schematically showing a sound field control system according to a first embodiment;

FIG. 2 is a diagram showing an example arrangement of a main sound source speaker, a first control sound source speaker, and a second control sound source speaker;

FIG. 3 is a block diagram showing the configuration of a remote controller according to the first embodiment;

FIG. 4 is a block diagram showing the details of a sound field control system according to the first embodiment;

FIG. 5 is a flowchart showing the flow of a process of sound field control according to the first embodiment;

FIG. 6 is a diagram showing measurement of the characteristic of spatial transmission from the main sound source speaker and the first and second control sound source speakers to a microphone contained in the remote controller;

FIG. 7 is a diagram showing an example of transition of sound field coefficients α and β corresponding to a listening area and a non-listening area during automatic adjustment;

FIG. 8 is a diagram showing an example of the sound field control effect corresponding to a first combination of the sound field coefficients α and β;

FIG. 9 is a diagram showing an example of the sound field control effect corresponding to a second combination of the sound field coefficients α and β;

FIG. 10 is a diagram showing an example of the sound field control effect corresponding to a third combination of the sound field coefficients α and β;

FIG. 11 is a diagram showing an example of the sound field control effect corresponding to a fourth combination of the sound field coefficients α and β;

FIGS. 12A and 12B are diagrams showing examples of predicted sound field control effects;

FIGS. 13A and 13B are diagrams showing examples of measured sound field control effects;

FIG. 14 is a diagram schematically showing a sound field control system according to a second embodiment;

FIG. 15 is a block diagram showing the details of a control effect display unit according to the second embodiment;

FIG. 16 is a block diagram showing the details of the sound field control system according to the second embodiment;

FIG. 17 is a diagram schematically showing a sound field control system according to a third embodiment;

FIG. 18 is a diagram showing a matrix array microphone according to the third embodiment;

FIG. 19 is a block diagram showing the details of the sound field control system according to the third embodiment;

FIG. 20 is a diagram showing a specific example of arrangement of a microphone contained in the remote controller and a matrix array microphone according to the third embodiment;

FIG. 21 is a diagram showing a result of calculation of a sound pressure level on a side wall surface at 200 Hz, wherein the microphones are arranged as shown in FIG. 20;

FIG. 22 is a diagram showing a result of calculation of a sound pressure level on an opposite side wall surface at 200 Hz, wherein the microphones are arranged as shown in FIG. 20;

FIGS. 23A and 23B are a top view and a side view showing an example of installation of a matrix array microphone according to a fourth embodiment;

FIGS. 24A and 24B are a top view and a side view showing another example of installation of the matrix array microphone according to the fourth embodiment;

FIG. 25 is a diagram showing another example of installation of the matrix array microphone according to the fourth embodiment;

FIG. 26 is a diagram showing yet another example of installation of the matrix array microphone according to the fourth embodiment; and

FIG. 27 is a diagram showing an example of installation of a linear array microphone that is a modification of the fourth embodiment.

### DETAILED DESCRIPTION OF THE INVENTION

Embodiments of the present invention will be described below with reference to the drawings.

### First Embodiment

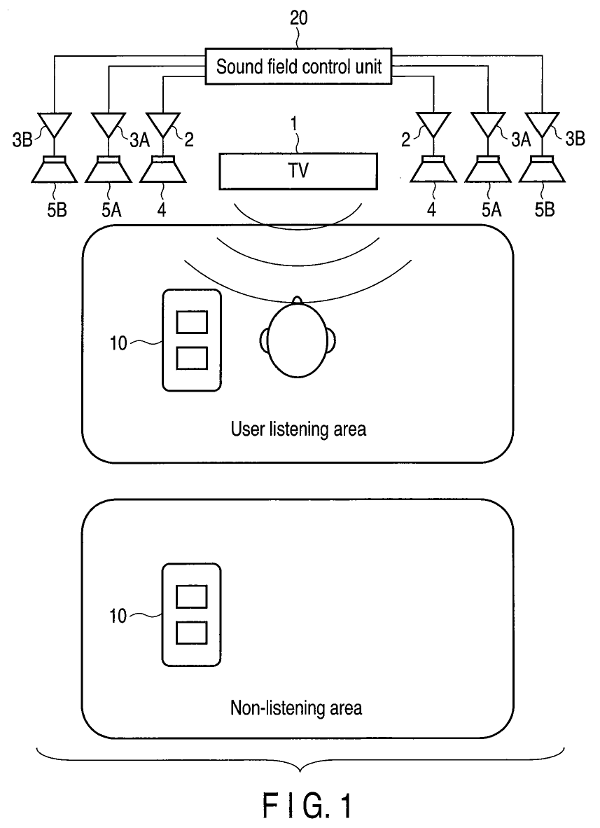

A first embodiment will be described in brief with reference to FIG. 1. In FIG. 1, an AV apparatus is assumed which has TV 1, amplifiers 2, 3A, and 3B, a main sound source speaker 4 driven by the amplifier 2, and a first control sound source speaker 5A and a second control sound source speaker 5B driven by the amplifiers 3A and 3B, and can be controlled by a remote controller 10 with a built-in microphone.

The sound field control unit 20 cooperates with the remote controller 10 in controlling inputs to the amplifiers 2, 3A, and 3B. Thus, the sound field control unit controls sound fields formed by the main sound source speaker 4 and the control sound source speakers 5A and 5B so that at the same time and in the same space, with a sound field suiting a user's taste maintained, the amount of contents sounds reaching a surrounding non-listening area in which a person different from the user is present is minimized.

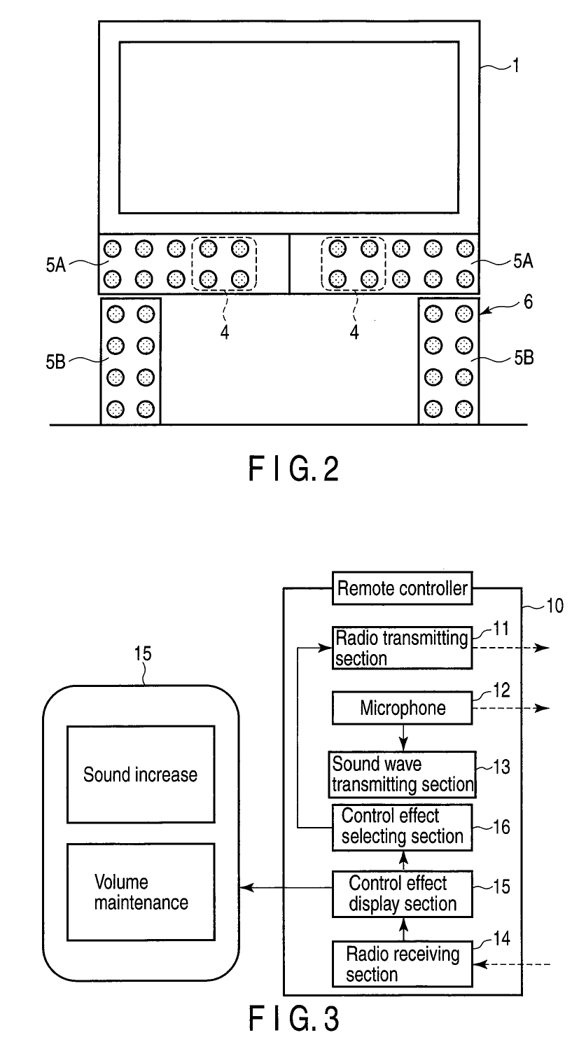

The amplifiers 2, 3A, 3B, the main sound source speaker 4, and the control sound source speakers 5A and 5B may be contained in TV 1 or provided separately from TV 1 as shown in FIG. 2, or both a device contained in TV 1 and a device provided separately from TV 1. FIG. 2 shows an example in which the main sound source speaker 4 and first and second control sound source speakers 5A and 5B, each of which is provided for each of a right channel and a left channel, are arranged so as to form a TV stand 6. The amplifiers 2, 3A, and 3B may be contained in the TV stand 6.

For sound field control, the user first operates the remote controller 10 in a listening area A to input a sound field control command. The operation of inputting the sound field control command allows a sound field control unit 20 to measure the characteristics of spatial transmission, in the listening area A, from the main sound source speaker 4 and control sound source speakers 5A and 5B to the microphone contained in the remote controller.

Then, the user moves to a non-listening area B and operates the remote controller 10 to input the sound field control command to similarly allow the sound field control unit 20 to measure the characteristics of spatial transmission, in the non-listening area B, from the main sound source speaker 4 and control sound source speakers 5A and 5B to the microphone contained in the remote controller.

On the basis of the thus-measured spatial transmission characteristics, the sound field control unit 20 instantaneously predicts a plurality of types of sound field control effects that can be exerted in the listening area A and in the non-listening area B. The sound field control unit 20, for example, sequentially displays the predicted plurality of types of sound field control effects on a screen of the remote controller 10 or TV 1. The user can thus check the plurality of types of sound source control effects in the non-listening area which cannot be listened to directly in the listening area A.

The user checks the sound field control effects in the non-listening area B to select an appropriate one from the different, realizable sound field control effects. After the selection of the sound field control effect, a control sound source signal corresponding to the selected sound field control effect is generated using a contents sound signal as a source. According to the control sound source signal, control sound sources are output by the control sound source speakers 5A and 5B to control the sound fields in the listening area A and the non-listening area B. As a result, the user's desired sound fields are realized.

FIG. 3 shows an example of the remote controller 10 having, for example, a radio transmitting section 11 using infrared rays, a microphone (hereinafter referred to as a microphone contained in the remote controller) 12, a sound wave transmitting section 13 that preferably transmits a sound wave (for example, an ultrasonic wave) of a frequency band outside an audible band, a radio receiving section 14, a control effect display section 15, and a control effect selecting section 16. The elements of the remote controller 10 will be described below.

The radio transmitting section 11 enables radio transmission from the remote controller 10 to the sound field control unit 20, specifically, transmits the sound field control command generated by operating the remote controller 10 and transmits sound field control effect information selected by the user to the sound field control unit 20. The sound wave transmitting section 13 transmits a signal detected by the microphone 12 contained in the remote controller to the sound field control unit 20 as a sound wave in order to allow the sound field control unit 20 to measure the spatial transmission characteristic. The radio receiving section 14 receives and passes the sound field control effect information transmitted by the sound field control unit 20, to the control effect display section 15.

The control effect display section 15 is set in a part of a display screen of the remote controller 10 such as a liquid crystal display. The control effect display section 15 simultaneously displays sound field control effects in the two spaces (listening area A and non-listening area B) exerted by the sound field control unit 20, as shown in the left of FIG. 3. In this case, the control effect display section 15, for example, sequentially displays the plurality of types of sound field control effects as a menu, from which the user can use the control effect selecting section 16 to select one of the sound field control effects. Information indicating the sound field control effect selected via the control effect selecting section 16 is transmitted to the sound field control unit 20 by the radio transmitting section 11.

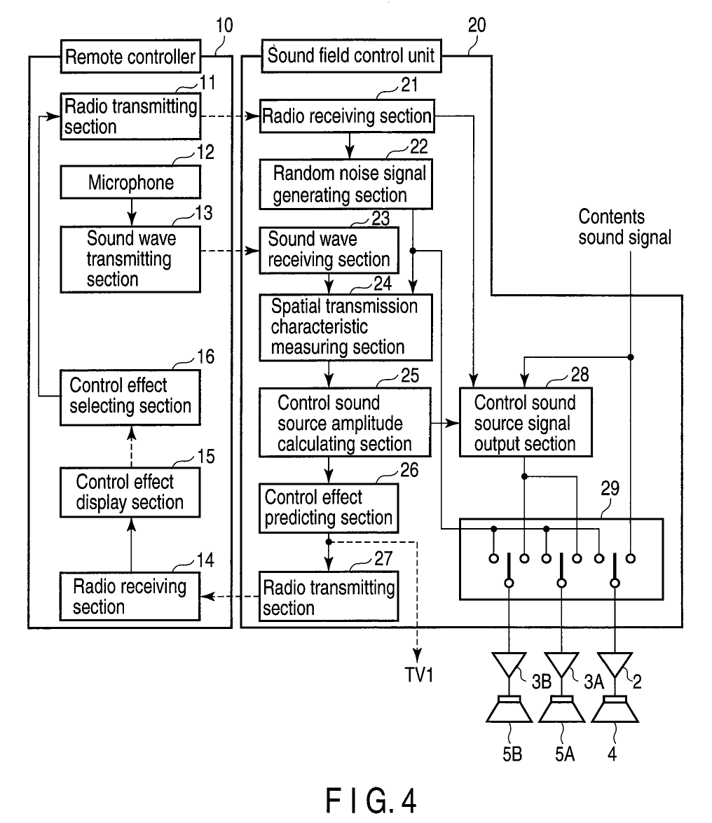

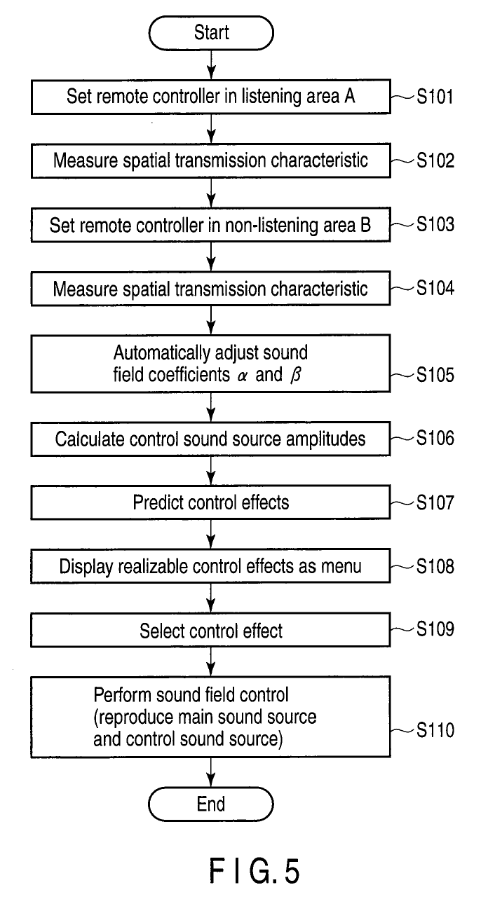

On the other hand, as shown in FIG. 4, the sound field control unit 20 has a radio receiving section 21, a random noise signal generating section 22, a sound wave receiving section 23, a spatial transmission characteristic measuring section 24, a control sound source amplitude calculating section 25, a control effect predicting section 26, a radio transmitting section 27, a control sound source signal output section 28, and a switch 29. The elements of the sound field control unit 20 will be described below.

The radio receiving section 21 receives and communicates a sound field control command transmitted by the radio transmitting section 11 of the remote controller 10, to the random noise signal generating section 22. Upon receiving the sound field control command, the random noise signal generating section 22 generates a random noise signal in order to allow a random noise sound used for measurement of the spatial transmission characteristic to be output from the main sound source speaker 4 and the control sound source speakers 5A and 5B via the amplifiers 2, 3A, and 3B. The sound wave receiving section 23 receives a sound wave transmitted by the sound wave transmitting section 13 of the remote controller 10 and passes the received signal to the spatial transmission characteristic measuring section 24.

On the basis of the random noise signal and the signal received from the sound wave receiving section 13, the spatial transmission characteristic measuring section 24 measures the characteristic of spatial transmission from the main sound source speaker 4 and the control sound source speakers 5A and 5B to the microphone 12 contained in the remote controller. The control sound source amplitude calculating section 25 calculates the amplitude of the control sound source for sound field control according to the measured spatial transmission characteristic. Information on the control sound source amplitude calculated by the control sound source amplitude calculating section 25 is passed to the control effect predicting section 26 and the control sound source signal output section 28.

The control effect predicting section 26 predicts the possible sound field control effects in the listening area A and the non-listening area B (specifically, predicts whether or not to increase or reduce the volume or to maintain the volume). The sound field control effect information obtained by the control effect predicting section 26 is input to the radio transmitting section 27 and supplied to TV 1 as required. The radio transmitting section 27 transmits the sound field control effect information. The sound field control effect information transmitted by the radio transmitting section 27 is received by the radio receiving section 14 of the remote controller 10.

On the other hand, the control sound source signal output section 28 uses a contents sound signal as a source to generate and output a control sound source signal having the control sound source amplitude calculated by the control sound source amplitude calculating section 25 as well as a control sound source phase. The control sound source signal is sent to the amplifiers 3A and 3B via the switch 29. The amplifiers 3A and 3B drive the control sound source speakers 5A and 5B according to the control sound source signal to allow the control sound source to be output from the control sound source speakers 5A and 5B.

When the spatial transmission characteristic is measured, the switch 29 sequentially supplies the random noise signal from the random noise signal generating section 22 to the amplifiers 2, 3A, and 3B. On the other hand, when the sound field is controlled after the spatial transmission characteristic has been measured, the switch 29 supplies the contents sound signal to the amplifier 2, while supplying the control sound source signal from the control sound source output section 28 to the amplifiers 3A and 3B.

Now, the flow of operation of the sound field control system according to the present embodiment will be described with reference to a flowchart shown in FIG. 4.

First, the user sets the remote controller 10 in the listening area A (step S101). That is, the user operates the remote controller 10 in the listening area A to transmit the sound field control command from the radio transmitting section 11. The sound field control command thus transmitted from the remote controller 10 is received by the radio receiving section 21 of the sound field control unit 20.

Thus, in the sound field control unit 20, the random noise signal generating section 22 generates a random noise signal, which is supplied to the amplifiers 2, 3A, and 3B by the switch 29. Thus, according to the random noise signal, a random noise sound is output from the main sound source speaker 4 and the control sound source speakers 5A and 5B. The random noise sound is detected by the microphone 12 contained in the remote controller. A detection signal from the microphone 12 contained in the remote controller is transmitted by the sound wave transmitting section 13 as a sound wave, which is then received by the sound wave receiving section 23. On the basis of a detection signal output by the sound wave receiving section 23 and the random noise signal, the spatial transmission characteristic measuring section 24 measures the characteristic of spatial transmission from the main sound source speaker 4 and the control sound source speakers 5A and 5B to the microphone 12 contained in the remote controller placed in the listening area A (step S102).

Then, the user sets the remote controller 10 in the non-listening area B (step S103), and operates the remote controller 10 in the listening area A to similarly measure the characteristic of spatial transmission from the main sound source speaker 4 and the control sound source speakers 5A and 5B to the microphone 12 contained in the remote controller placed in the non-listening area B (step S104).

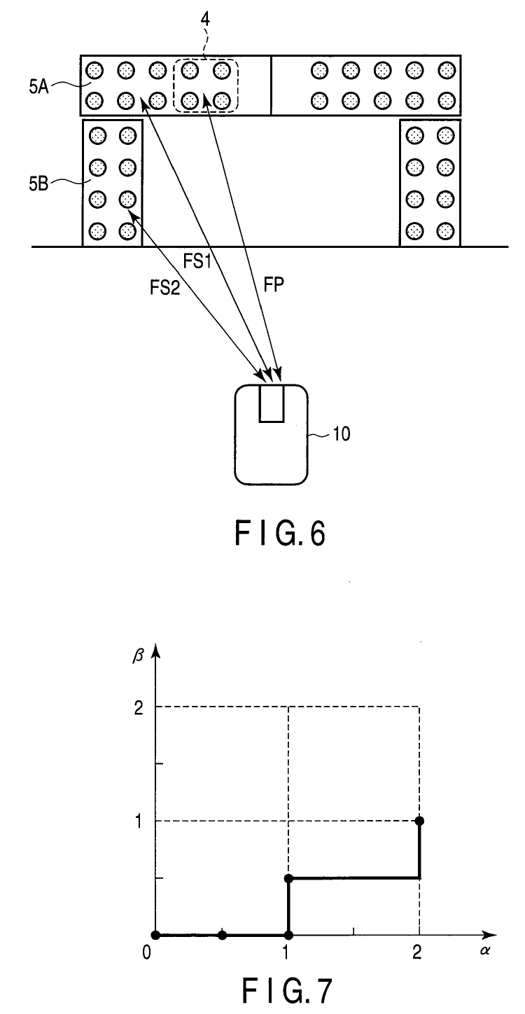

In step S102, the following are sequentially measured according to formulae shown below: a characteristic Fp of spatial transmission from the main sound source speaker 4 to the microphone 12 contained in the remote controller and placed in the listening area A, a characteristic Fs1 of spatial transmission from the first control sound source speaker 5A to the microphone 12 contained in the remote controller and placed in the listening area A, and a characteristic Fs2 of spatial transmission from the second control sound source speaker 5B to the microphone 12 contained in the remote controller and placed in the listening area A (see FIG. 6).

$$\begin{matrix}{F}_{p} = {\sum }_{i = 1}^{{N}_{p}} \frac{ρ j ω {e}^{- j {kr}_{pi}}}{4 π {r}_{pi}} & [ Formula 1 ] \\ {F}_{S 1} = {\sum }_{i = 1}^{{N}_{S 1}} \frac{ρ j {ωe}^{- j {kr}_{S 1 i}}}{4 π {r}_{S 1 i}} & [ Formula 2 ] \\ {F}_{S 2} = {\sum }_{i = 1}^{{N}_{S 2}} \frac{ρ j {ωe}^{- j {kr}_{S 2 i}}}{4 π {r}_{S 2 i}} & [ Formula 3 ]\end{matrix}$$

In the formulae, ρ denotes the density of air, Nₚ denotes the number of point sound sources which are considered to be contained in the main sound source speaker and into which the main sound source speaker can be divided, Nₛ₁ denotes the number of point sound sources which are considered to be contained in the first control sound source speaker and into which the first control sound source speaker can be divided, and Nₛ₂ denotes the number of point sound sources which are considered to be contained in the second control sound source speaker and into which the second control sound source speaker can be divided. Furthermore, rₚᵢ denotes a distance from the i-th point sound source in the main sound source to the microphone 12 contained in the remote controller placed in the listening area A, rₛ₁ᵢ denotes a distance from the i-th point sound source in the first control sound source to the microphone 12 contained in the remote controller placed in the listening area A, and rₛ₂ᵢ denotes a distance from the i-th point sound source in the second control sound source to the microphone 12 contained in the remote controller placed in the listening area A.

In step S104, similarly, the following are sequentially measured according to formulae shown below: a characteristic Zₚ of spatial transmission from the main sound source speaker 4 to the microphone 12 contained in the remote controller and placed in the non-listening area B, a characteristic Zₛ₁ of spatial transmission from the first control sound source speaker 5A to the microphone 12 contained in the remote controller and placed in the non-listening area B, and a characteristic Zₛ₂ of spatial transmission from the second control sound source speaker 5B to the microphone 12 contained in the remote controller and placed in the listening area A.

$$\begin{matrix}{Z}_{p} = {\sum }_{i = 1}^{{N}_{p}} \frac{ρ j {ωe}^{- j {kL}_{pi}}}{4 π {L}_{pi}} & [ Formula 4 ] \\ {Z}_{S 1} = {\sum }_{i = 1}^{{N}_{S 1}} \frac{ρ j ω {e}^{- j {kL}_{S 1 i}}}{4 π {L}_{S 1 i}} & [ Formula 5 ] \\ {Z}_{S 2} = {\sum }_{i = 1}^{{N}_{S 2}} \frac{ρ j ω {e}^{- j {kL}_{S 2 i}}}{4 π {L}_{S 2 i}} & [ Formula 6 ]\end{matrix}$$

In the formulae, ρ denotes the density of air, Nₚ denotes the number of point sound sources which are considered to be contained in the main sound source speaker and into which the main sound source speaker can be divided, Nₛ₁ denotes the number of point sound sources which are considered to be contained in the first control sound source speaker and into which the first control sound source speaker can be divided, and Nₛ₂ denotes the number of point sound sources which are considered to be contained in the second control sound source speaker and into which the second control sound source speaker can be divided. Furthermore, Lₚᵢ denotes a distance from the i-th point sound source in the main sound source to the microphone 12 contained in the remote controller placed in the non-listening area B, Lₛ₁ᵢ denotes a distance from the i-th point sound source in the first control sound source to the microphone 12 contained in the remote controller placed in the non-listening area B, and rₛ₂ᵢ denotes a distance from the i-th point sound source in the second control sound source to the microphone 12 contained in the remote controller placed in the non-listening area B.

In this case, sound field control is performed such that a sound pressure observed in the listening area A after the sound field control is α times as high as a sound pressure from only the main sound source before the control and such that a sound pressure observed in the non-listening area B after the sound field control is β times as high as the sound pressure from only the main sound source before the control. This sound field control is expressed by the following formula.

q_{P}F_{P}+q_{S1}F_{S1}+q_{S2}F_{S2} [symbol] α·q_{P}Fₚ

q_{P}Z_{P}+q_{S1}Z_{S1}+q_{S2}Z_{S2} [symbol] β·q_{P}Z_{P} [Formula 7]

Then, α and β (hereinafter referred to as sound field coefficients) are automatically adjusted, for example, along a thick line in FIG. 7 (step S105). The control sound source signal amplitude is subsequently calculated (step S106). In the example shown in FIG. 7, basically, α and β can each be adjusted within the range from 0 to 2 but are automatically adjusted to one of four combinations (a) α=2 and β=1, (b) α=1 and β=½, (c) α=1 and β=0, and (d) α=½ and β=0.

For example, setting the sound field coefficient α to the following values enables an increase or a reduction in sound pressure in the listening area A.

α>1 sound increase

α=1 maintenance

0<α<1 sound reduction

α=0 minimum (infinite) [Formula 8]

Setting another sound field coefficient β to the following values enables an increase or a reduction in sound pressure in the non-listening area B.

β>1 sound increase

β=1 maintenance

0<β<1 sound reduction

β=0 minimum (infinite) [Formula 9]

A formula shown below expresses the relationship between the amplitude qₚ of the main sound source output from the main sound source speaker 4 and the amplitudes q_{S1} nd q_{S2} of the control sound sources output from the two control sound source speakers 5A and 5B.

$$∴ ( \begin{matrix}{q}_{S 1} \\ {q}_{S 2}\end{matrix} ) = {( \begin{matrix}{F}_{S 1} & {F}_{S 2} \\ {Z}_{S 1} & {Z}_{S 2}\end{matrix} )}^{- 1} ( \begin{matrix}( α - 1 ) {F}_{P} \\ ( β - 1 ) {Z}_{P}\end{matrix} ) {q}_{P} \qquad [ Formula 10 ]$$

Since the main sound source is an original contents sound and is known, the control sound source amplitudes q_{S1} and q_{S2} can be calculated from the main sound source amplitude qₚ. In this case, a formula shown below expresses sound pressure levels ηA(dB) and ηB at points in the listening area A and the non-listening area B where the microphone 12 contained in the remote controller is set.

η_{A}≅20 log α

η_{B}≅20 log β [Formula 11]

After the control sound source amplitudes q_{S1} and q_{S2} are calculated, the control effect predicting section 26 predicts a plurality of types of sound field control effects corresponding to various combinations of α and β (step S107).

Desirably, after the sound field control effects are predicted, determinations expressed by a formula shown below are performed.

q_{S1}·N_{S1}≦q_{P}·N_{P}

q_{S2}·N_{S2}≦q_{P}·N_{P} [Formula 12]

Formula (12) expresses conditions for control sound source amplitude≦main sound source amplitude in terms of a volume velocity ratio. If the conditions in Formula (12) are not met, the volume velocity of the control sound source can be reduced so as to meet the conditions in Formula (12) by inverting the characteristic Fₛ₂ of spatial transmission from the second control sound source speaker 5B to the microphone 12 contained in the remote controller and placed in the listening area A, to −Fₛ₂.

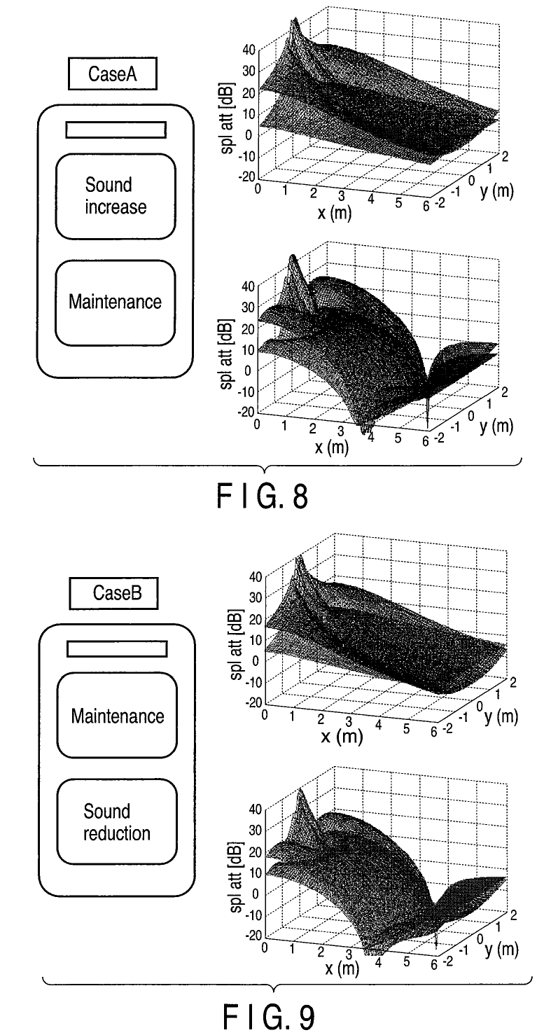

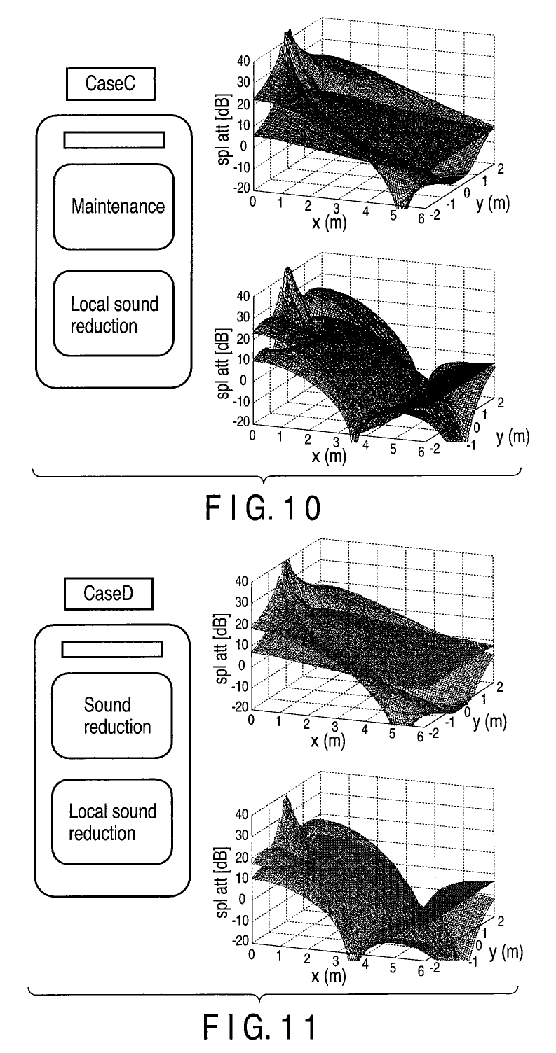

FIGS. 8 to 11 show examples of the sound field control effects corresponding to the various combinations of α and β shown in FIG. 7. In Case A shown in FIG. 8, α=2 and β=1, that is, 6 dB (sound increase) in the listening area A and 0 dB (sound pressure maintenance) in the non-listening area B. In Case B shown in FIG. 9, α=1 and β=½, that is, 0 dB (sound pressure maintenance) in the listening area A, and −6 dB (sound reduction) in the non-listening area B. In Case C shown in FIG. 10, α=1 and β=0, that is, 0 dB (sound pressure maintenance) in the listening area A, and −∞ dB (local sound reduction) in the non-listening area B. In Case D shown in FIG. 11, α=½ and β=0, that is, −6 dB (sound reduction) in the listening area A, and −∞ dB (local sound reduction) in the non-listening area B. All the sound field control effects shown in FIGS. 8 to 11 are assumed to meet the conditions in Formula (12).

When each of α and β is 2 at a maximum, that is, with an increase or decrease in sound pressure by about 6 dB, the volume of TV can be adjustably increased or reduced by 5 to 6 levels. Thus, the sound field control effects in the listening area A and the non-listening area B can be predicted step by step by varying α and β at certain increments within the ranges of 0<α<2 and 0<β<2, shown in FIG. 7.

Thus, information indicating the sound field control effects predicted by the control effect predicting section 26 is transmitted to the remote controller 10 by the radio transmitting section 27. The remote controller 10 allows the radio receiving section 14 to receive the information indicating the sound field control effects. The remote controller 10 then allows the control effect display section 15 to display the plurality of types (in this example, four types) of sound field control effects shown in FIGS. 8 to 11 so that the sound field control effects are sequentially switched, to present the sound field control effects to the user.

Then, the user selects one of the plurality of types of sound field control effects displayed by the control effect selecting section 16 (step S109). As a result, sound field control is performed so as to exert the selected sound field control effect (step S110).

Step S110 will be specifically described below. When one of the sound field control effects is selected via the control effect selecting section 16, the information indicating the selected sound field control effect is transmitted by the radio transmitting section 11. The information indicating the thus selected sound field control effect is received by the radio receiving section 21 of the sound field control unit 20 and then transferred to the control sound source signal output section 28. The control sound source signal output section 28 outputs a control sound source signal based on one of the control sound source amplitudes calculated by the control sound source amplitude calculating section 25 and corresponding to the plurality of types of sound field control effects which corresponds to the selected sound field control effect.

The control sound source signal output by the control sound source output section 28 is supplied to the amplifiers 3A and 3B via the switch 29. The control sound source speakers 5A and 5B are then driven by the amplifiers 3A and 3B to output control sound sources. Thus, sound field control is performed such that the desired sound field control effect selected by the user is exerted in the listening area A and in the non-listening area B.

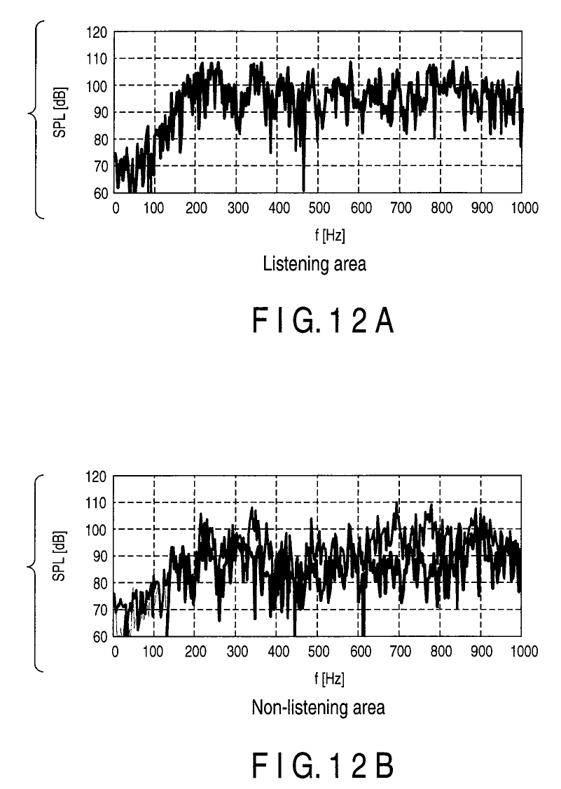

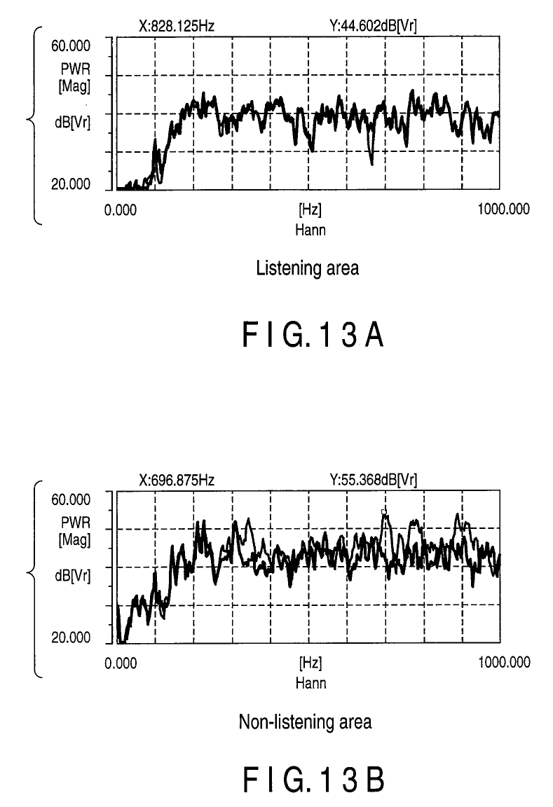

FIGS. 12A and 12B show the results of prediction of characteristics of spatial transmission, in an actual 12-mat living room, from a speaker to the position (evaluation point) of the microphone 12 contained in the remote controller; the remote controller is placed 1.5 m in front of and 0.55 m above the floor, and 4 m in front of and 1.05 m above the floor. FIGS. 13A and 13B show results of actual measurement of the sound field control effects under the same conditions as those in FIGS. 12A and 12B.

As shown in FIGS. 12A and 13A, the sound pressure observed at a position 1.5 m in front of the speaker, corresponding to the user listening area A, remains unchanged after the sound field control. That is, the measurement result matches the prediction result. On the other hand, for the sound pressure observed at a position away from the speaker, that is 4 m in front of the speaker, which position corresponds to the non-listening area B, a comparison of the measurement result with the prediction result shows that the sound pressure decreases in almost the same bands.

Both results relate to only on point where the microphone is set. In spite of the single evaluation point, not all the sound field distributions shown in FIGS. 8 to 11 show a decrease in sound field only at that point, but an increase or decrease in sound field appears uniformly all around the point. Thus, the spatial fields clearly shown in FIGS. 8 to 11 on the basis of the prediction can be presented to the user.

### Second Embodiment

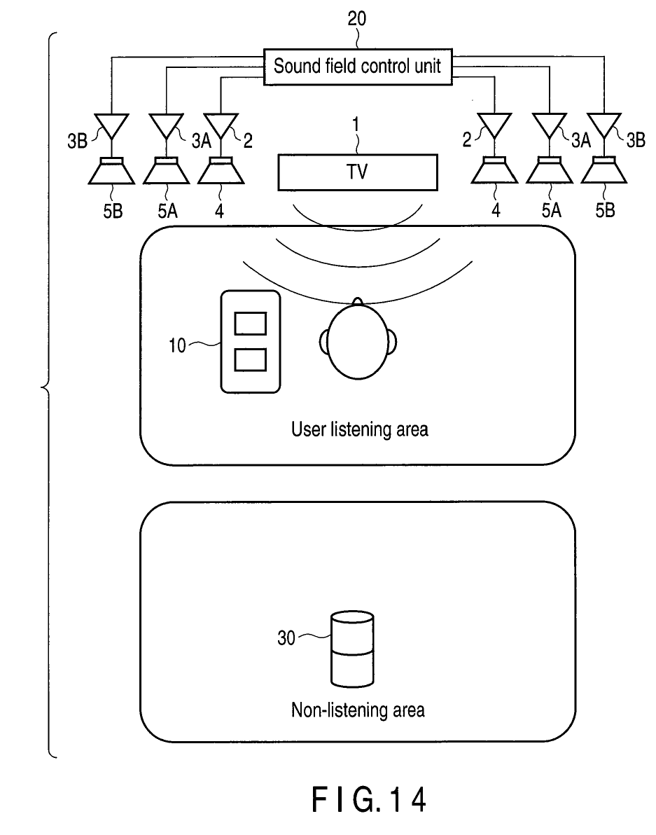

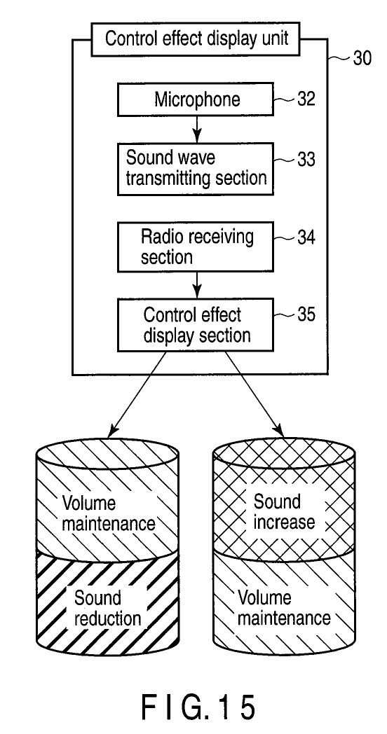

Now, a second embodiment of the present invention will be described with reference to FIGS. 14, 15, and 16. In the second embodiment, as shown in FIG. 14, a sound field control display unit 30 with a built-in microphone is installed in the non-listening area B. As shown in FIG. 15, the control effect display unit 30 has a microphone 32 (the microphone contained in the display unit), a sound wave transmitting section 33, a radio receiving section 34, and a control effect display section 35, which have functions similar to those of the microphone 12 in the remote controller 10, the sound wave transmitting section 13, the radio receiving section 14, and the control effect display section 15 according to the first embodiment, respectively.

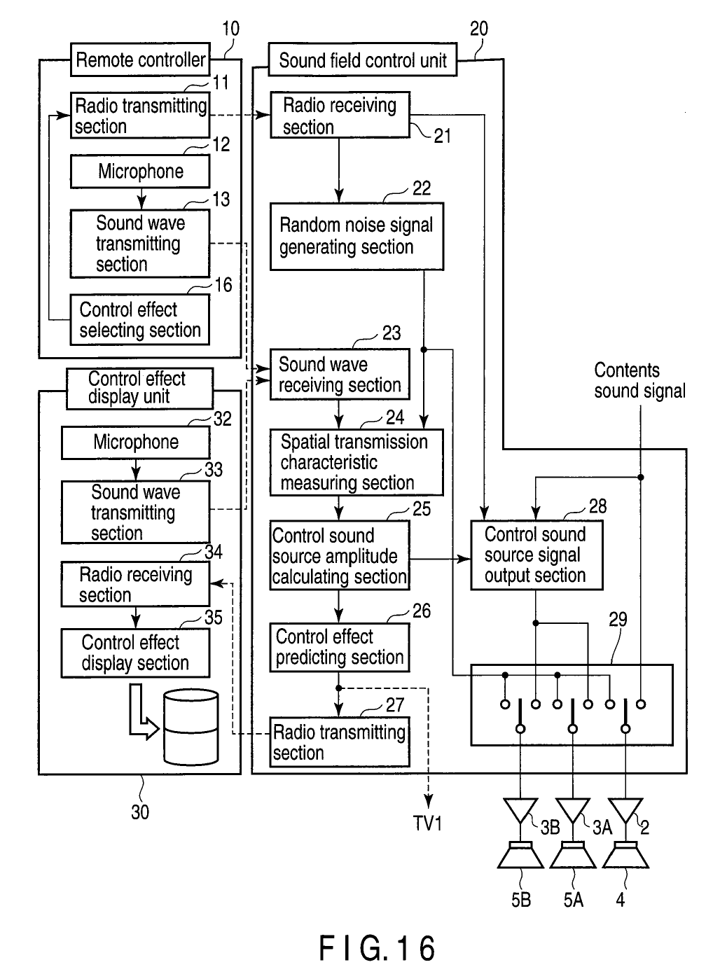

On the other hand, as shown in FIG. 16, the remote controller 10 according to the present embodiment has the radio transmitting section 11, the microphone 12, the sound wave transmitting section 13, and the control effect display section 16; the radio receiving section 14 and the control effect display section 15, provided in the remote controller 10 according to the first embodiment, are omitted from the remote controller 10 according to the second embodiment. The sound field control unit 20 in FIG. 16 is similar to that in the first embodiment.

The flow of a process according to the present embodiment will be described. The user first operates the remote controller 10 in the listening area A to measure the characteristic of spatial transmission from the main sound source speaker 4 and the control sound source speakers 5A and 5B to the microphone 12 contained in the remote controller set in the listening area A, as is the case with the first embodiment. The user subsequently measures the characteristic of spatial transmission from the main sound source speaker 4 and the control sound source speakers 5A and 5B to the microphone 32 in the control effect display unit 30 installed in the non-listening area B.

In the latter measurement of the spatial transmission characteristic, a random noise sound from the main sound source speaker 4 and the control sound source speakers 5A and 5B is detected by the microphone 32 contained in the display unit. A detection signal from the microphone 32 is transmitted by the sound wave transmitting section 33 as a sound wave, which is received by the sound wave receiving section 23 of the sound field control unit 20. On the basis of the detection signal output by the sound wave receiving section 23 and the random signal from the random noise signal receiving section 22, the spatial transmission characteristic measuring section 24 measures the characteristic of spatial transmission from the main sound source speaker 4 and the control sound source speakers 5A and 5B to the microphone 32.

Then, the control sound source amplitude calculating section 25 calculates the control sound source amplitude on the basis of the spatial transmission characteristic measured as described above. The control effect predicting section 26 further predicts a plurality of types of sound field control effects. Information indicating the sound field control effects predicted by the control effect predicting section 26 is transmitted to the control effect display unit 30 by the radio transmitting section 27.

The control effect display unit 30 allows the radio receiving section 34 to receive the transmitted information indicating the sound field control effects. The control effect display unit 30 then allows the control effect display section 35 to display the plurality of types of sound field control effects shown in FIGS. 8 to 11 so that the sound field control effects are sequentially switched, to present the sound field control effects to the user. When the user selects one of the thus displayed plurality of types of sound field control effects, sound field control is performed so as to exert the selected sound field control effect, as is the case with the first embodiment.

With an ordinary life scene assumed, the non-listening area B, that is, the position that the contents sounds from the AV apparatus are desired not to reach, is limited to some degree. In this case, the control effect display unit 30 effectively resides in the non-listening area B as in the case of the present embodiment.

The control effect display section 35 in the control effect display unit 30 can display the sound field control effects using, instead of letters, the brightness of the display or a variation in display color effected by LEDs (Light-Emitting Diodes) or the like, for example, as shown in FIG. 15. In FIG. 15, differences in display brightness or color are represented by the corresponding types of hatching in the display of the sound field control effects.

This display allows the user in the listening area A to easily check the sound field control effects even though the control effect display unit 30 is installed in the non-listening area B. Thus, the control effect display section can be omitted from the remote controller 10 carried by the user in the listening area A. This enables a reduction in the weight and size of the remote controller 10.

### Third Embodiment

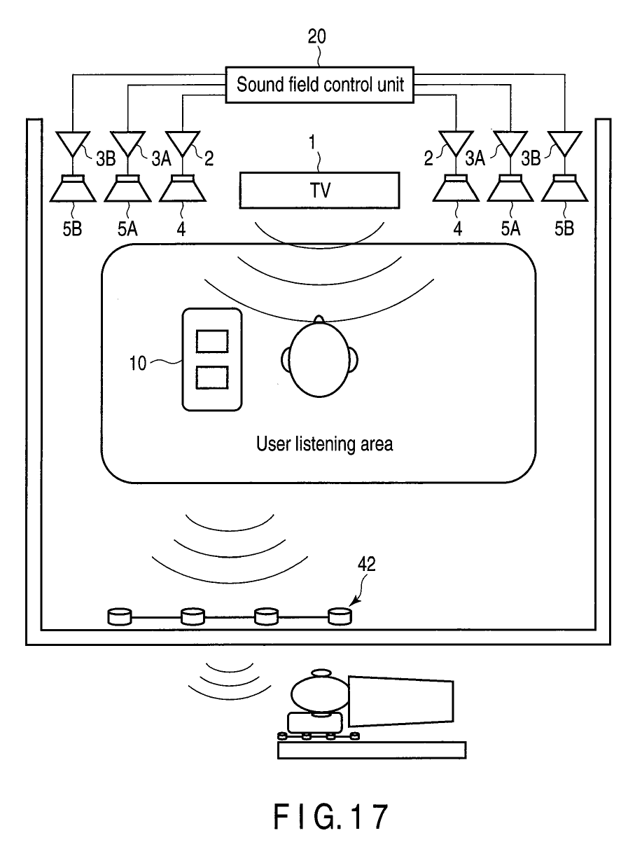

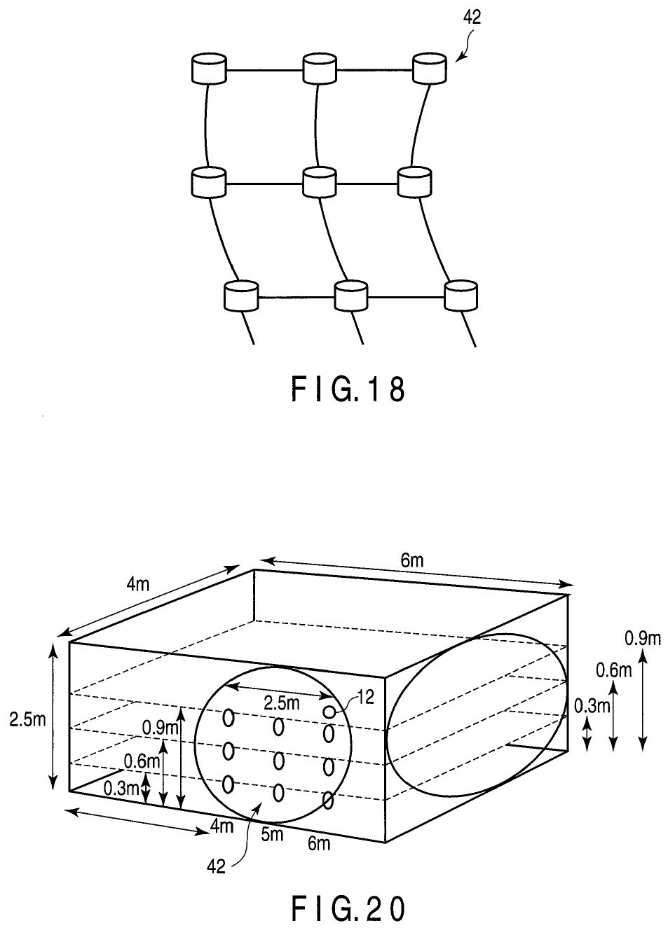

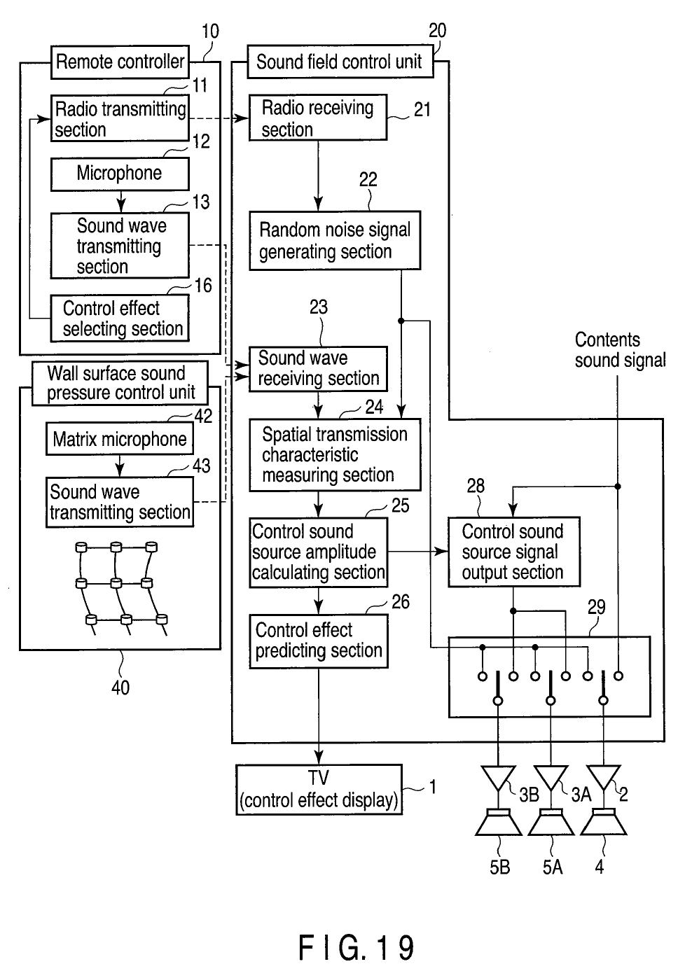

Now, a third embodiment of the present invention will be described with reference to FIGS. 17 to 22. The present embodiment performs sound field control on sounds passing through walls. In general, the wall exhibits a lower sound insulation performance in a bass range. Thus, contents sounds are transmitted to the non-listening area B through the wall behind which the non-listening area B is located. According to the present embodiment, this situation is assumed. As shown in FIG. 17, a wall surface sound pressure control unit 40 (see FIG. 19) is installed inside a wall surface that is to inhibit transmission of contents sounds (that is, the wall surface at the boundary between the listening area A and the non-listening area B); the wall surface sound pressure control unit 40 comprises a matrix array microphone 42 having a large number of element microphones arranged in a matrix as shown in FIG. 18. When the listening area A and the non-listening area B are partitioned by a curtain, the matrix array microphone 42 may be installed on the curtain.

As shown in FIG. 19, the wall surface sound pressure control unit 40 includes the matrix array microphone 42 and a sound wave transmitting section 43 that transmits a detection signal from the matrix array microphone 42 as a sound wave. The remote controller 10 in FIG. 19 is similar to that in the second embodiment. The sound field control unit 20 is almost similar to that in the first and second embodiments.

The flow of a process according to the present embodiment will be described. The user first operates the remote controller 10 in the listening area A to measure the characteristic of spatial transmission from the main sound source speaker 4 and the control sound source speakers 5A and 5B to the microphone 12 contained in the remote controller as is the case with the first embodiment. The user subsequently measures the characteristic of spatial transmission from the main sound source speaker 4 and the control sound source speakers 5A and 5B to the matrix array microphone 42 in the wall surface sound pressure control unit 40. More specifically, the matrix array microphone 42 measures a sound pressure exerted on the inside of the wall surface.

In the latter measurement of the spatial transmission characteristic, a random noise sound from the main sound source speaker 4 and the control sound source speakers 5A and 5B is detected by the matrix array microphone 42 in the wall surface sound pressure control unit 40. A detection signal from the microphone 42 is transmitted by the sound wave transmitting section 43 as a sound wave, which is received by the sound wave receiving section 23 of the sound field control unit 20. On the basis of the detection signal output by the sound wave receiving section 23 and the random signal, the spatial transmission characteristic measuring section 24 measures the characteristic of spatial transmission from the main sound source speaker 4 and the control sound source speakers 5A and 5B to the matrix array microphone 42.

Then, the control sound source amplitude calculating section 25 calculates the control sound source amplitude on the basis of the spatial transmission characteristic measured as described above. The control effect predicting section 26 further predicts a plurality of types of sound field control effects. Information indicating the sound field control effects predicted by the control effect predicting section 26 is transmitted to TV 1 or to the control effect display section (not shown in the drawings) in the remote controller 10 by the radio transmitting section, as is the case with the first embodiment.

As a result, TV 1 or the control effect display section displays the plurality of types of sound field control effects shown in FIGS. 8 to 11 so that the sound field control effects are sequentially switched, to present the sound field control effects to the user. Then, when the user selects one of the thus displayed plurality of types of sound field control effects, sound field control is performed so as to exert the selected sound field control effect as is the case with the first embodiment.

Here, since the matrix array microphone 42 is provided on the wall surface, acoustic energy applied to the wall surface can be reduced by performing control such that the square sum of sound pressures detected by the element microphones of the matrix array microphone 42 is minimized. As a result, sounds from the listening area A which are transmitted through the wall surface and radiated to the non-listening area B can be suppressed.

In FIG. 20, the microphone 12 contained in the remote controller is set 2.5 m away from a speaker in a room (listening area A) surrounded by walls, with respect to a front surface (a surface located in the upper left of FIG. 20) of the room. The matrix array microphone 42 with nine element microphones is installed on a side wall surface (a surface in FIG. 20 which is closer to the reader).

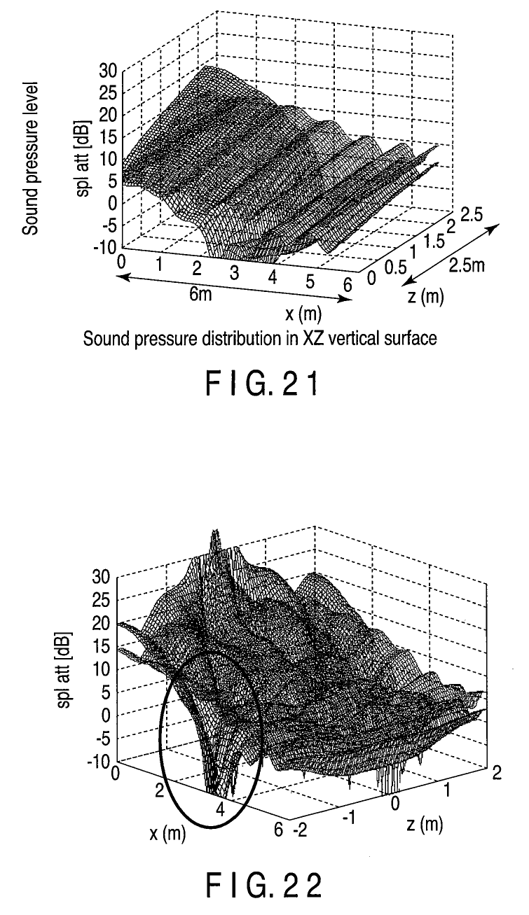

FIGS. 21 and 22 show the results of calculation of the sound pressure level on the side wall surface (XY vertical surface) and on the opposite wall surface (the right surface in FIG. 20) in FIG. 20 at a frequency of 200 Hz, wherein the microphone 12 contained in the remote controller and the matrix array microphone 42 are arranged as shown in FIG. 20. The results of the calculation indicate that the sound pressure is maintained at the position of the microphone 12 contained in the remote controller and that on the wall surface, the square sum of the sound pressures detected by the nine element microphones of the matrix array microphone 42 is minimized. This in turn indicates that sound leakage through the wall surface is inhibited.

### Fourth Embodiment

Now, a fourth embodiment of the present invention obtained by applying the third embodiment will be described. The present embodiment shows an example in which the matrix array microphone 42 according to the third embodiment is installed on a place different from the wall surface.

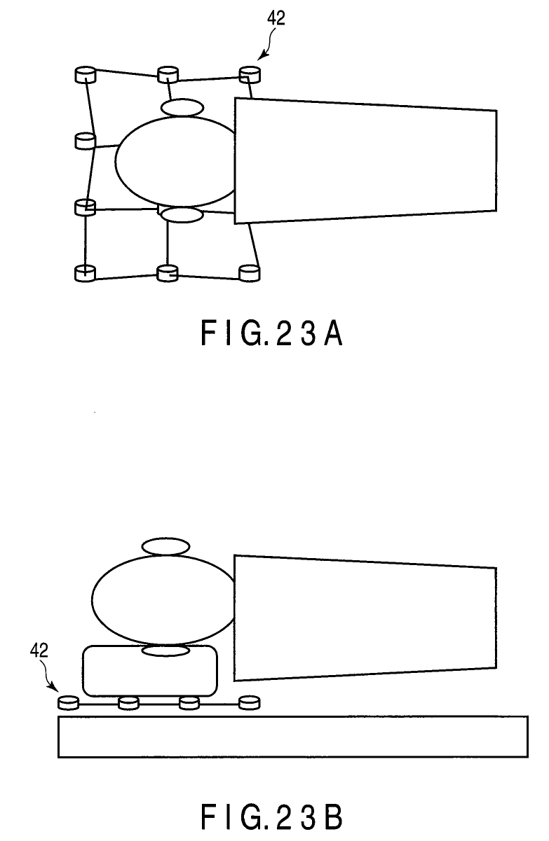

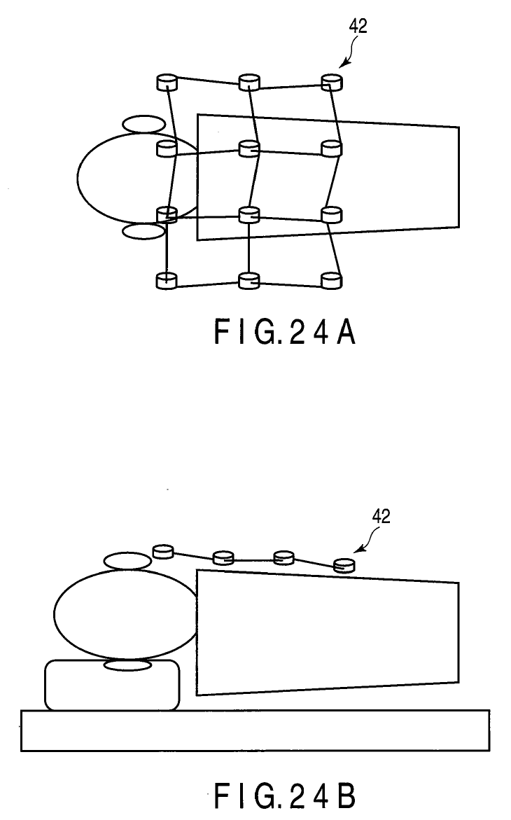

FIGS. 23A and 23B show an example in which the matrix array microphone 42 is installed under a pillow in the non-listening area B, on which a person sleeps. FIGS. 24A and 24B show an example in which the matrix array microphone 42 is laid over a quilt in the non-listening area B, which covers the person when the person sleeps. With the matrix array microphone 42 installed as described above, contents sounds (particularly bass) passing through the wall can be suppressed around the ears of the person in the non-listening area B.

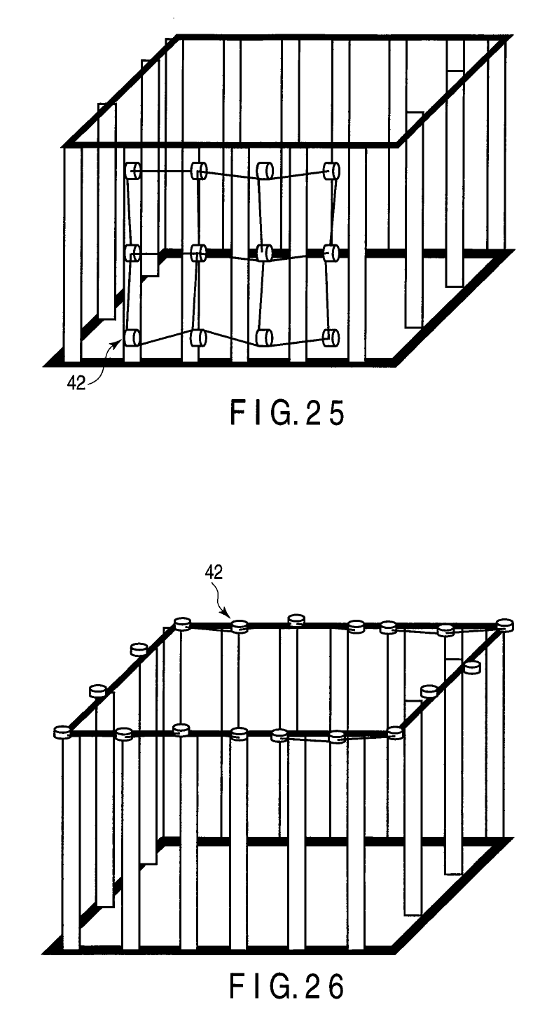

FIGS. 25 and 26 show an example in which the matrix array microphone 42 is installed around the periphery of a baby bed or on a handrail thereof. Thus, contents sounds that a baby in the baby bed hears can be suppressed.

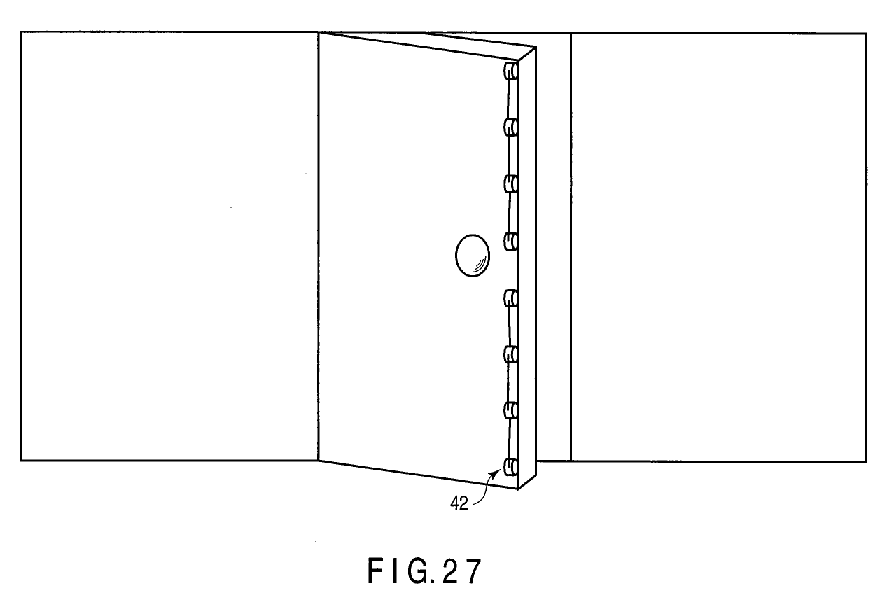

In another modification of the embodiment, a linear array microphone 52 such as the one shown in FIG. 27 can be used instead of the matrix array microphone. For example, the linear array microphone 52 may be installed along a gap created when the door is opened as shown in FIG. 27. By thus providing, in a limited way, the array microphone in an area where significant local sound leakage is likely to occur, the entry of contents sounds from the listening area to the non-listening area can be effectively prevented.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A sound field control method of controlling a sound field generated by an AV apparatus including a speaker, comprising:
measuring a characteristic of spatial transmission from the speaker to a first microphone contained in a remote controller for controlling the AV apparatus when the first microphone is placed in a listening area;
measuring the characteristic of spatial transmission from the speaker to the first microphone or another, second microphone when the first or second microphone is placed in a non-listening area;
calculating amplitudes of control sound sources corresponding to a plurality of different types of sound field control effects on the basis of the spatial transmission characteristics;
predicting the plurality of types of sound field control effects according to the amplitudes;
displaying and presenting the plurality of types of sound field control effects to a user;
outputting a control sound source with the amplitude and a phase corresponding to one sound field control effect selected from the plurality of types of sound field control effects by the user operating the remote controller; and
using the control sound source to drive the speaker in order to exert the one sound field control effect.

2. The method according to claim 1, wherein the second microphone is contained in a display unit installed in the non-listening area and configured to display the plurality of types of sound field control effects.

3. The method according to claim 1, wherein the second microphone is installed at least either at a boundary between the listening area and the non-listening area or in the non-listening area.

4. A sound field control system controlling a sound field generated by an AV apparatus including a speaker, comprising:
a first microphone contained in a remote controller for controlling the AV apparatus;
a generation unit which generates a random noise signal;
a transmission unit provided in the remote controller to transmit a detection signal output from the first microphone or the first microphone and another, second microphone on the basis of a random noise sound output from the speaker in response to the random noise signal;
a reception unit which receives the transmitted detection signal;
a measurement unit which uses the received detection signal to measure a characteristic of spatial transmission from the speaker to the first microphone contained in the remote controller for controlling the AV apparatus when the first microphone is placed in a listening area, and the characteristic of spatial transmission from the speaker to the first microphone or the second microphone when the first or second microphone is placed in a non-listening area;
a calculation unit which calculates amplitudes of control sound sources corresponding to a plurality of different types of sound field control effects on the basis of the spatial transmission characteristics;
a prediction unit which predicts the plurality of types of sound field control effects according to the amplitudes;
a display unit which displays and presents the plurality of types of sound field control effects to a user;
an output unit which outputs a control sound source with the amplitude and a phase corresponding to one sound field control effect selected from the plurality of types of sound field control effects by the user operating the remote controller; and
an amplifier which allows the control sound source to drive the speaker in order to exert the one sound field control effect.

5. The system according to claim 4, wherein the display unit is provided in the remote controller.

6. The system according to claim 4, wherein the display unit is provided in a display unit installed in the non-listening area, and
the second microphone is contained in the display unit.

7. The system according to claim 4, wherein the second microphone is installed at least either at a boundary between the listening area and the non-listening area or in the non-listening area.

8. The system according to claim 7, wherein the second microphone includes an array microphone with a plurality of element microphones arranged in a matrix.

9. The system according to claim 7, wherein the second microphone includes an array microphone with a plurality of linearly arranged element microphones.

10. The system according to claim 4, wherein the plurality of types of sound field control effects represent combinations of any of increase, decrease, maintenance, and minimization of a spatial sound pressure in the listening area and any of increase, decrease, maintenance, and minimization of a spatial sound pressure in the non-listening area.
